(19) United States
(12) Patent Application Publication
(10) Pub. No.: US 2025/0356644 A1
(43) Pub. Date: Nov. 20, 2025

(54) INFORMATION PROCESSING DEVICE, INFORMATION PROCESSING METHOD, AND STORAGE MEDIUM STORING PROGRAM

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Reiya KAWAMOTO, Nisshin-shi (JP); Sakon YAMAMOTO, Nisshin-shi (JP)

(21) Appl. No.: 19/098,399

(22) Filed: Apr. 2, 2025

(30) Foreign Application Priority Data
May 16, 2024 (JP) 2024-080346
Oct. 31, 2024 (JP) 2024-191562

(51) Int. Cl. G06V 10/82; G06V 10/28; G06V 10/74; G06V 20/58

(52) U.S. Cl. CPC G06V 10/82; G06V 10/28; G06V 10/761; G06V 20/58

(57) ABSTRACT

An information processing device includes a storage device configured to store a neural network and a quantization parameter, and an arithmetic circuit. The neural network includes a specific intermediate layer and a quantization layer that quantizes data, which is a set of values output by the specific intermediate layer, based on the quantization parameters. The arithmetic circuit executes repeated processing that repeatedly executes arithmetic processing that obtains an output result of the neural network by inputting image data into the neural network and stores the data output by the specific intermediate layer in the storage device, and in parallel with the repeated processing, executes modification processing that modifies the quantization parameter based on a distribution of values in the data stored in the storage device.

### CROSS REFERENCE TO RELATED APPLICATION

This application is based on Japanese Patent Application No. 2024-080346 filed on May 16, 2024 and Japanese Patent Application No. 2024-191562 filed on Oct. 31, 2024, the disclosure of which is incorporated herein by reference.

### TECHNICAL FIELD

The technology disclosed in this specification relates to information processing using a neural network.

### BACKGROUND

A related art discloses a technique for quantizing data output by an intermediate layer of a neural network. In this technique, multiple calibration image data are input into a pre-trained neural network as part of a calibration process. This allows for the identification of the distribution of values (specifically, the maximum and minimum values) in the data output by the intermediate layer, and based on the identified distribution, quantization parameters (specifically, Z value and S value) for quantizing the data are determined. During the inference phase, quantization is performed based on the quantization parameters determined during the calibration process. Quantization reduces the computational load in the neural network.

### SUMMARY

An information processing device includes a storage device configured to store a neural network and a quantization parameter, and an arithmetic circuit. The neural network includes a specific intermediate layer and a quantization layer that quantizes data, which is a set of values output by the specific intermediate layer, based on the quantization parameters. The arithmetic circuit executes repeated processing that repeatedly executes arithmetic processing that obtains an output result of the neural network by inputting image data into the neural network and stores the data output by the specific intermediate layer in the storage device, and in parallel with the repeated processing, executes modification processing that modifies the quantization parameter based on a distribution of values in the data stored in the storage device.

### BRIEF DESCRIPTION OF DRAWINGS

Objects, features and advantages of the present disclosure will become more apparent from the following detailed description made with reference to the accompanying drawings. In the drawings:

FIG. 1 is a block diagram of the information processing device;

FIG. 2 is a block diagram of the neural network;

FIG. 3 is a flowchart showing the NN arithmetic processing and quantization parameter change processing of the first embodiment;

FIG. 4 is a flowchart showing the determination processing of the start condition in the first example;

FIG. 5 is a flowchart showing the determination processing of the start condition in the second example;

FIG. 6 is a flowchart showing the determination processing of the start condition in the third example;

FIG. 7 is a flowchart showing the NN arithmetic processing, similarity determination processing, and quantization parameter change processing of the second embodiment;

FIG. 8 is an explanatory diagram of the image data used for similarity determination; and

FIG. 9 is a histogram of pixel values of pixel data in an example.

### DETAILED DESCRIPTION

In the technique disclosed in a related art, quantization is performed during the inference phase using the quantization parameters determined during the calibration process. In other words, the quantization parameters are fixed during the inference phase. Therefore, if an image with a distribution of pixel values different from that of the calibration image data used in the calibration process is input during the inference phase, significant errors may occur during quantization.

Additionally, a quantization technique known as Dynamic Quantization is known. In Dynamic Quantization, the distribution of data output by the intermediate layer is calculated during the inference phase, and based on the calculated distribution, quantization parameters are determined, and quantization is performed based on the determined quantization parameters. According to this technique, quantization errors can be reduced. However, in this technique, the calculation of quantization parameters and the processing of the quantization layer are executed sequentially on the output data of the intermediate layer, resulting in longer processing times for the neural network.

The present disclosure provides a technique that reduces quantization errors while suppressing the increase in processing time.

According to one aspect of the present disclosure, an information processing device includes a storage device configured to store a neural network and a quantization parameter, and an arithmetic circuit. The neural network includes a specific intermediate layer and a quantization layer that quantizes data, which is a set of values output by the specific intermediate layer, based on the quantization parameters. The arithmetic circuit executes repeated processing that repeatedly executes arithmetic processing that obtains an output result of the neural network by inputting image data into the neural network and stores the data output by the specific intermediate layer in the storage device, and in parallel with the repeated processing, executes modification processing that modifies the quantization parameter based on a distribution of values in the data stored in the storage device.

This information processing device has an arithmetic circuit that executes modification processing (i.e., processing to modify the quantization parameters) in parallel with arithmetic processing. In the modification processing, the arithmetic circuit modifies the quantization parameters based on the distribution of values in the data stored in the storage device (i.e., data previously output by the intermediate layer). Therefore, in the arithmetic processing after the modification processing, quantization is performed according to the modified quantization parameters. In this way, since the quantization parameters are modified according to the data output by the intermediate layer, quantization errors can be reduced. Additionally, in this information processing device, since the arithmetic circuit executes the modification processing in parallel with the arithmetic processing, the time required for processing from the intermediate layer to the quantization layer is short. In other words, the processing time of the neural network is short. As described above, according to this information processing device, it is possible to reduce quantization errors while suppressing the increase in processing time.

In the information processing device, the arithmetic circuit may accumulate multiple data output by the specific intermediate layer in the storage device during multiple arithmetic processing operations. The arithmetic circuit may modify the quantization parameter based on the distribution of values in the multiple data accumulated in the storage device during the modification processing.

According to this configuration, the frequency of executing the modification processing is reduced, thereby reducing the computational load on the arithmetic circuit and shortening the processing time.

The information processing device may be mounted on a vehicle. The information processing device may further include a camera that captures images in front of the vehicle. The arithmetic circuit may input the image data captured by the camera into the neural network during the arithmetic processing.

According to this configuration, the images in front of the vehicle can be analyzed by the neural network. Since the processing time of the neural network is short, the images in front of the vehicle can be analyzed with higher real-time performance.

In the aforementioned information processing device, the arithmetic circuit may determine the timing for executing the modification processing based on the travel distance of the vehicle.

According to this configuration, even if the input image data (i.e., scenery, etc.) changes due to the travel of the vehicle, quantization error can be reduced by modifying the quantization parameter.

In the aforementioned information processing device, the arithmetic circuit may determine the timing for executing the modification processing based on the location information of the vehicle.

According to this configuration, even if the input image data (i.e., scenery, etc.) changes due to the change in the vehicle's location, quantization errors can be reduced by modifying the quantization parameter.

In the aforementioned information processing device, the arithmetic circuit may determine the timing for executing the modification processing based on time.

In the aforementioned information processing device, during the arithmetic processing, the arithmetic circuit may store the image data input into the neural network in the storage device. The arithmetic circuit may identify at least one first image data and at least one second image data that is input into the neural network before the first image data from the image data stored in the storage device, and execute the modification processing when the similarity between the first image data and the second image data is lower than a reference value.

The term “similarity” here refers to an index indicating that the higher the similarity, the more similar the first image data and the second image data are, and the lower the similarity, the less similar they are.

According to this configuration, when the input image data changes significantly (i.e., when the similarity decreases), quantization errors can be reduced by modifying the quantization parameter.

According to this configuration, even if the input image data (i.e., scenery, etc.) changes due to the passage of time, quantization errors can be reduced by modifying the quantization parameter.

In the aforementioned information processing device, the arithmetic circuit may identify the amount of change in the quantization parameters during the modification processing and determine the timing for executing the next modification processing such that the interval until the next modification processing becomes longer as the amount of change becomes smaller.

According to this configuration, the frequency of executing the modification processing can be reduced when the amount of change in the quantization parameters is small, thereby reducing the computational load on the arithmetic circuit.

Furthermore, the processing executed by the aforementioned information processing device can also be realized as an information processing method, a program, or a computer-readable recording medium on which the program is recorded.

### First Embodiment

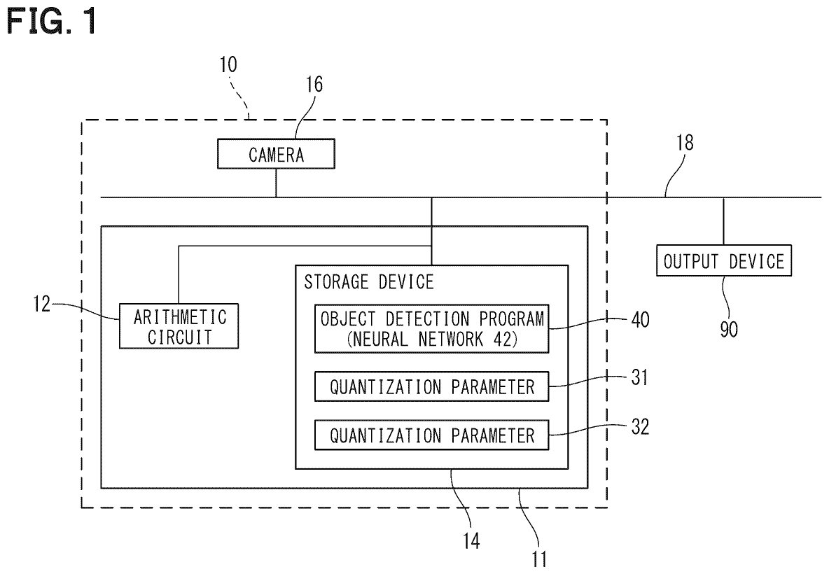

The information processing device 10 of the first embodiment shown in FIG. 1 is mounted on a vehicle such as an automobile or a motorcycle. The information processing device 10 captures images in front of the vehicle and detects objects (e.g., pedestrians, other vehicles, obstacles) from the captured images. The information processing device 10 transmits the detection results to an output device 90 mounted on the vehicle. For example, the output device 90 may be a display device. In this case, the output device 90 can display the position and type of the objects identified by the information processing device 10. In vehicles with driving assistance functions or autonomous vehicles, the output device 90 may be a device that controls the vehicle's driving (e.g., a device that controls acceleration/deceleration or steering angle). In this case, the output device 90 can control the vehicle's speed and steering angle based on the detection results from the information processing device 10.

The information processing device 10 includes a computer 11 and a camera 16. The computer 11, camera 16, and output device 90 are connected to each other via a data bus 18 provided in the vehicle. The camera 16 captures images in front of the vehicle. The computer 11 includes an arithmetic circuit 12 and a storage device 14. The storage device 14 includes non-volatile memory and may also include volatile memory. The storage device 14 stores an object detection program 40 and quantization parameters 31, 32. The quantization parameters 31, 32 are values defined as variables within the object detection program 40 and can be considered part of the object detection program 40. The object detection program 40 includes a neural network 42. The arithmetic circuit 12, composed of a CPU or the like, executes various calculations. The arithmetic circuit 12 can execute the object detection program 40.

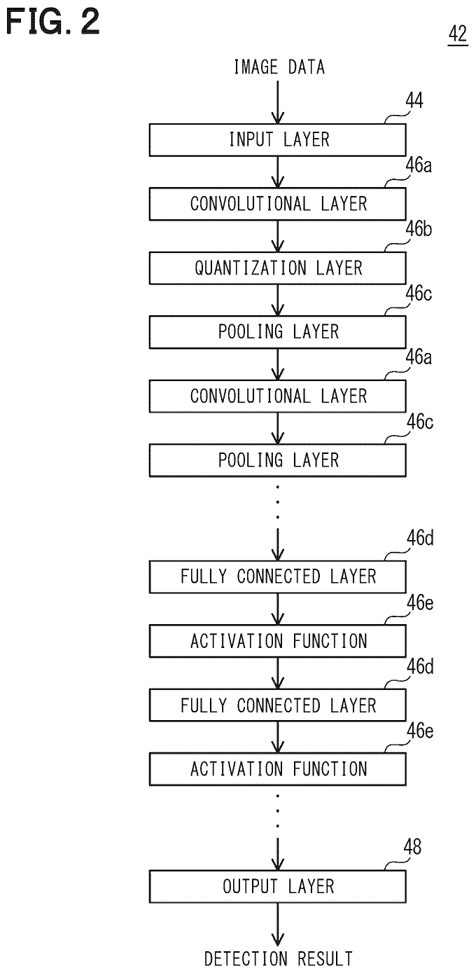

The neural network 42 is a pre-trained neural network. FIG. 2 shows the configuration of the neural network 42. As shown in FIG. 2, the neural network 42 includes multiple intermediate layers 46 between an input layer 44 and an output layer 48. Image data captured by the camera 16 is input to the input layer 44. In the first half of the neural network 42, convolutional layers 46a and pooling layers 46c are alternately arranged to extract features from the image. In the second half of the neural network 42, fully connected layers 46d and activation functions 46e are alternately arranged to identify objects in the image. Any activation function (e.g., step function, sigmoid function, tanh function, ReLU function, softmax function) can be used as the activation function 46e. The output layer 48 outputs the type and position (i.e., the position in the image) of the objects identified in the image as detection results. The neural network 42 also includes a quantization layer 46b. The quantization layer 46b quantizes the data output by the first convolutional layer 46a.

When the vehicle starts, the arithmetic circuit 12 executes the object detection program 40. The arithmetic circuit 12 captures images in front of the vehicle using the camera 16 and performs neural network arithmetic processing (hereinafter referred to as NN arithmetic processing) on the captured image data. NN arithmetic processing is a so-called inference process. In NN arithmetic processing, the arithmetic circuit 12 inputs the image data into the neural network 42, performs calculations according to each intermediate layer 46, and outputs the detection results from the output layer 48. The arithmetic circuit 12 repeatedly executes NN arithmetic processing while the vehicle is running, detecting objects in front of the vehicle in real-time.

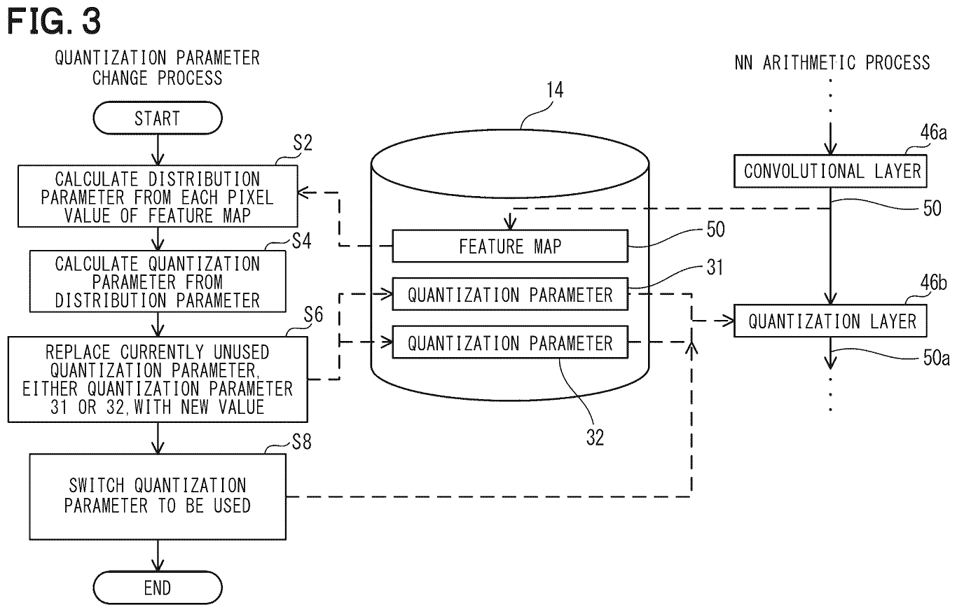

The flowchart on the right side of FIG. 3 shows the processing executed in the convolutional layer 46a and the quantization layer 46b of the neural network 42. In the convolutional layer 46a, the arithmetic circuit 12 applies a filter to the image data input from the previous layer and outputs a feature map 50. The feature map 50 is image data and a collection of pixel values (i.e., scalar values), forming a tensor. Each pixel value of the feature map 50 is represented as FP32 (i.e., a 32-bit floating-point number). The feature map 50 is input to the quantization layer 46b. In the quantization layer 46b, the arithmetic circuit 12 quantizes the feature map 50 based on one of the quantization parameters 31, 32. More specifically, in the quantization layer 46b, the arithmetic circuit 12 converts each pixel value of the feature map 50 from FP32 to INT8 (i.e., an 8-bit integer) based on one of the quantization parameters 31, 32. Note that in the quantization layer 46b, each pixel value may be converted from FP32 to INT16, INT4, or other formats. The details regarding which of the quantization parameters, 31 or 32, to be used will be explained later. Each of the quantization parameters 31, 32 includes a Z value and an S value. In the quantization layer 46b, the arithmetic circuit 12 converts the FP32 value x to the INT8 value q using the following equation 1:

$$q = Z + round ( x / S ) \qquad ( Equation 1 )$$

The round function in the equation 1 is a function that rounds the value x/S to an integer, such as a rounding function. As is clear from the equation 1, the S value represents the width when rounding the value. The Z value determines the zero point of the value q. In this way, in the quantization layer 46b, the arithmetic circuit 12 converts each pixel value of the feature map 50 from FP32 to INT8 and outputs the feature map 50a with the converted pixel values. By quantizing the feature map 50 in the quantization layer 46b, the computational load in subsequent NN arithmetic processing is reduced. Therefore, the arithmetic circuit 12 can execute NN arithmetic processing at high speed.

Additionally, the arithmetic circuit 12 stores the feature map 50 output by the convolutional layer 46a in the storage device 14. As described above, the arithmetic circuit 12 repeatedly executes NN arithmetic processing. Each time the arithmetic circuit 12 executes NN arithmetic processing, it stores the feature map 50 output by the convolutional layer 46a in the storage device 14. Therefore, the storage device 14 accumulates multiple feature maps 50 output in past NN arithmetic processing. Note that due to the limited storage capacity, the storage device 14 accumulates up to the last N feature maps 50.

The arithmetic circuit 12 executes quantization parameter change processing in parallel with NN arithmetic processing while repeating NN arithmetic processing. As described above, the quantization layer 46b uses one of the quantization parameters 31, 32. Immediately after the vehicle starts, the quantization parameters 31, 32 (i.e., S value and Z value) may be set to predetermined values or to the values from the last use of the vehicle. Either of the quantization parameters 31, 32 may be used first, but the following description will explain the quantization parameter change processing using quantization parameter 31 as an example.

When a predetermined start condition is met while the arithmetic circuit 12 is repeatedly executing NN arithmetic processing, it executes the quantization parameter change processing shown in FIG. 3. The start condition for the quantization parameter change processing will be described in detail later. When the quantization parameter change processing starts, the arithmetic circuit 12 reads the feature maps 50 from the storage device 14 in step S2. Here, the arithmetic circuit 12 reads N feature maps 50 accumulated in the storage device 14 from the past N times of NN arithmetic processing operations. Based on the pixel values of the multiple read feature maps 50, the arithmetic circuit 12 calculates parameters indicating the distribution of the pixel values (hereinafter referred to as distribution parameters). For example, the arithmetic circuit 12 calculates the maximum value Max and the minimum value Min of the pixel values of the multiple feature maps 50 as distribution parameters. The maximum value Max and the minimum value Min may be calculated directly from the pixel values or by removing outliers from the pixel values. Alternatively, the arithmetic circuit 12 may calculate the average value and variance of the pixel values and then calculate the expected maximum and minimum values based on the average value and variance as the maximum value Max and the minimum value Min.

Next, in step S4, the arithmetic circuit 12 calculates the S value and Z value as quantization parameters from the distribution parameters of the pixel values. For example, the S value can be calculated from the following equation 2:

$$S = ( Max - Min ) / 255 \qquad ( Equation 2 )$$

Additionally, the Z value can be calculated from the following equation 3:

$$Z = round ( - ( Max + Min ) / 2 S ) \qquad ( Equation 3 )$$

If the value q is an unsigned integer, the Z value can be calculated from the following equation 4 instead of the equation 3:

$$Z = round ( - Min / S ) \qquad ( Equation 4 )$$

Next, in step S6, the arithmetic circuit 12 rewrites the currently unused quantization parameter among the quantization parameters 31 and 32 with the quantization parameter calculated in step S4. During the first execution of the quantization parameter change processing, the quantization parameter 31 is used in the NN arithmetic processing, so the arithmetic circuit 12 rewrites the quantization parameter 32 with the value calculated in step S4. Then, in step S8, the arithmetic circuit 12 switches the quantization parameter used in the NN arithmetic processing. During the first execution of the quantization parameter change processing, the quantization parameter 31 is used in the NN arithmetic processing, so the arithmetic circuit 12 switches the quantization parameter from the quantization parameter 31 to the quantization parameter 32. As a result, the quantization parameter used in the quantization layer 46b is changed to the newly calculated value in step S6. Therefore, when the quantization layer 46b is executed after step S8, quantization is performed based on the newly calculated quantization parameter. As described above, the quantization parameter change processing changes the quantization parameter used in the quantization layer 46b.

When the start condition for the quantization parameter change processing is met again after the execution of the quantization parameter change processing, the arithmetic circuit 12 executes the quantization parameter change processing again. The arithmetic circuit 12 calculates the quantization parameters in steps S2 and S4. During the second execution of the quantization parameter change processing, quantization parameter 32 is used in the NN arithmetic processing, so in step S6, the arithmetic circuit 12 rewrites quantization parameter 31 with the new value. Then, in step S8, the arithmetic circuit 12 switches the quantization parameter used in the NN arithmetic processing from quantization parameter 32 to quantization parameter 31 (i.e., the newly calculated quantization parameter). Therefore, quantization is performed based on the newly calculated quantization parameter thereafter.

As described above, in the quantization parameter change processing, the arithmetic circuit 12 calculates new quantization parameters based on the pixel values of the N feature maps 50 accumulated in the storage device 14 and changes the quantization parameters used in the NN arithmetic processing to the new values. By repeatedly executing the quantization parameter change processing, the quantization parameters used in the NN arithmetic processing are updated to values that fit the distribution of the pixel values of the most recent feature maps. Since the image data input to the neural network 42 is the image in front of the vehicle, the distribution of the pixel values of the image data input to the neural network 42 does not change drastically in a short time. Therefore, the distribution of the pixel values of the feature maps 50 does not change drastically in a short time. Thus, by updating the quantization parameters to fit the pixel values of the most recent feature maps 50, quantization errors occurring in the quantization layer 46b can be reduced.

Next, examples of the start conditions for the quantization parameter change processing will be described.

### First Example

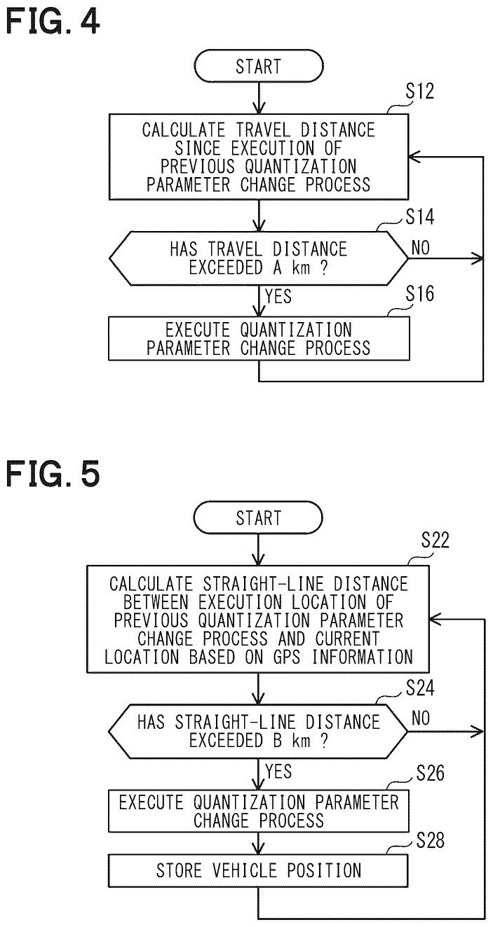

The start condition in the first example is that the vehicle's travel distance has reached a predetermined value. FIG. 4 shows the determination processing of the start condition in the first example. While repeating the NN arithmetic processing, the arithmetic circuit 12 executes the processing shown in FIG. 4. In step S12, the arithmetic circuit 12 calculates the distance traveled by the vehicle since the last execution of the quantization parameter change processing based on the detected value from the vehicle's odometer. Next, in step S14, the arithmetic circuit 12 determines whether the travel distance calculated in step S12 exceeds A km. The arithmetic circuit 12 repeats steps S12 and S14 until the result in step S14 is YES. If the result in step S14 is YES, the arithmetic circuit 12 executes the quantization parameter change processing in step S16.

When using the start condition of the first example, the quantization parameter change processing is executed each time the vehicle travels A km. Since the scenery in front of the vehicle is more likely to change as the travel distance increases, executing the quantization parameter change processing according to the travel distance allows for appropriate reduction of quantization errors.

### Second Example

The start condition in the second example is that the vehicle's position has changed. FIG. 5 shows the determination processing of the start condition in the second example. In the second example, the vehicle's position at the time of the last execution of the quantization parameter change processing is stored in the storage device 14 or the like. In step S22, the arithmetic circuit 12 obtains the current position of the vehicle from a GPS device mounted on the vehicle and calculates the straight-line distance between the current position and the position at the last execution of the quantization parameter change processing. Next, in step S24, the arithmetic circuit 12 determines whether the straight-line distance calculated in step S22 exceeds B km. The arithmetic circuit 12 repeats steps S22 and S24 until the result in step S24 is YES. If the result in step S24 is YES, the arithmetic circuit 12 executes the quantization parameter change processing in step S26 and then stores the vehicle's position at the time of execution in step S28.

When using the start condition of the second example, the quantization parameter change processing is executed when the vehicle's travel area significantly changes. Since the scenery in front of the vehicle is more likely to change when the travel area changes, executing the quantization parameter change processing according to the travel area allows for appropriate reduction of quantization errors.

When setting the start condition based on GPS information as in the second example, the arithmetic circuit 12 may identify the area information (e.g., urban area, suburban area, mountainous area) of the vehicle's current position based on the map data of a car navigation system and execute the quantization parameter change processing when the area information changes.

### Third Example

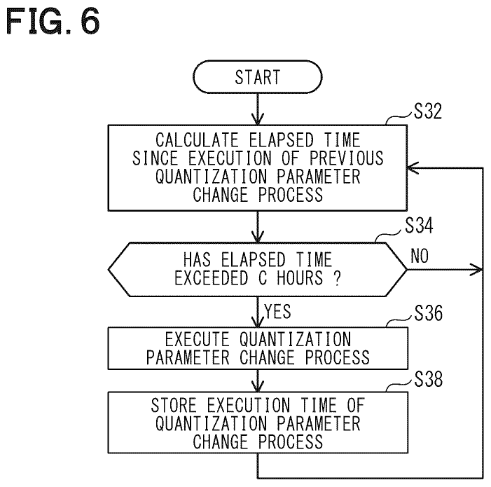

The start condition in the third example is that a predetermined time has elapsed. FIG. 6 shows the determination processing of the start condition in the third example. In the third example, the time of the last execution of the quantization parameter change processing is stored in the storage device 14 or the like. In step S32, the arithmetic circuit 12 calculates the elapsed time as the difference between the time of the last execution of the quantization parameter change processing and the current time. Next, in step S34, the arithmetic circuit 12 determines whether the elapsed time calculated in step S32 exceeds C hours. The arithmetic circuit 12 repeats steps S32 and S34 until the result in step S34 is YES. If the result in step S34 is YES, the arithmetic circuit 12 executes the quantization parameter change processing in step S36 and then stores the execution time in step S38.

When using the start condition of the third example, the quantization parameter change processing is executed when a predetermined time has elapsed. As time passes, the scenery changes not only due to the vehicle's travel but also due to changes in time (e.g., morning, noon, night). Therefore, executing the quantization parameter change processing according to the elapsed time allows for appropriate reduction of quantization errors. Instead of elapsed time, the quantization parameter change processing may be executed based on the time of day.

In the first to third examples, the threshold values (i.e., values A, B, and C shown in FIG. 4 to FIG. 6) for determining the timing of executing the quantization parameter change processing are fixed values. However, the threshold values may be changed according to the amount of change in the quantization parameters (i.e., S value, Z value) in the quantization parameter change processing. More specifically, the threshold values may be changed so that the interval until the next quantization parameter change processing becomes longer as the amount of change in the quantization parameters becomes smaller. For example, in the first example shown in FIG. 4, the arithmetic circuit 12 may calculate the amount of change in the quantization parameters in step S16 and increase the value A as the calculated amount of change becomes smaller. Similarly, in the second example shown in FIG. 5, the arithmetic circuit 12 may calculate the amount of change in the quantization parameters in step S26 and increase the value B as the calculated amount of change becomes smaller. In the third example shown in FIG. 6, the arithmetic circuit 12 may calculate the amount of change in the quantization parameters in step S36 and increase the value C as the calculated amount of change becomes smaller. When the amount of change in the quantization parameters is small, it is likely that the changes in the vehicle's travel environment will also be small thereafter. Therefore, even if the interval until the next quantization parameter change processing is extended when the amount of change in the quantization parameters is small, the quantization errors will not become significantly large. Additionally, by extending the interval until the next quantization parameter change processing, the computational load on the arithmetic circuit 12 can be reduced. Therefore, the arithmetic circuit 12 can perform NN arithmetic processing at a higher speed.

The start conditions of the first to third examples described above may be combined. Additionally, other conditions may be combined with the start conditions of the first to third examples.

In the aforementioned information processing device 10, the storage device 14 accumulates feature maps 50 for N times (also referred to as N feature maps 50), and the quantization parameter change processing is executed based on the pixel values of the accumulated feature maps 50. In other words, the frequency of executing the quantization parameter change processing is lower than the frequency of executing the NN arithmetic processing. According to this configuration, the computational load on the arithmetic circuit 12 can be reduced. Additionally, since the quantization parameters are modified based on N feature maps 50, the quantization parameters calculated in the quantization parameter change processing are stable even if the scenery in front of the vehicle changes temporarily. However, in other embodiments, the quantization parameter change processing may be executed once for each NN arithmetic processing. In other words, after the feature map 50 is stored in the storage device 14 during the NN arithmetic processing, the NN arithmetic processing and the quantization parameter change processing may be executed in parallel, and the quantization parameters for the next NN arithmetic processing may be modified by the quantization parameter change processing. In this case, new quantization parameters are calculated based on one feature map 50 in the quantization parameter change processing. Even with such a configuration, since the quantization parameter change processing and the NN arithmetic processing are executed in parallel, the NN arithmetic processing can be executed in a shorter time compared to the case where the quantization parameter change processing is performed during the NN arithmetic processing.

### Second Embodiment

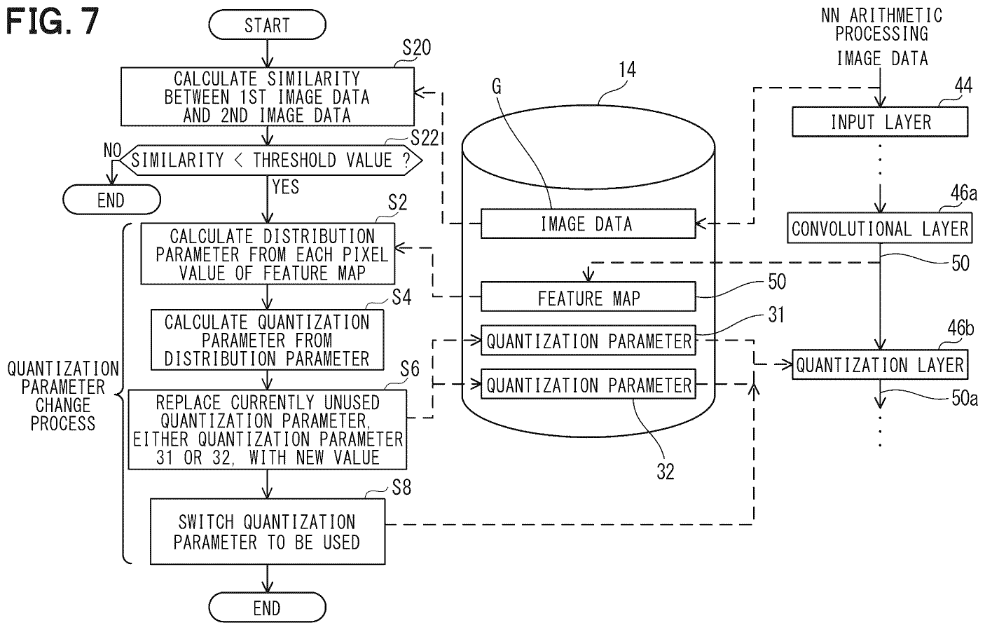

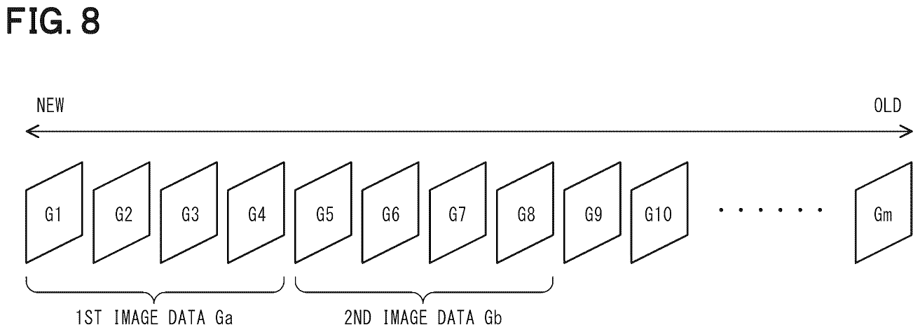

FIG. 7 shows the NN arithmetic processing and quantization parameter change processing of the second embodiment. In the NN arithmetic processing of the second embodiment, the arithmetic circuit 12 stores the image data (i.e., the image data captured by the camera 16) input to the input layer 44 in the storage device 14. The storage device 14 accumulates m image data inputs from the past m NN arithmetic processing operations. FIG. 8 shows the m image data G stored in the storage device 14. The numbers attached to the image data G indicate the recency of the image data, with image data G1 being the most recent image input to the input layer 44 in the latest NN arithmetic processing, and image data Gm being the image data input to the input layer 44 m−1 NN arithmetic processing operations ago. Except for storing the image data G in the storage device 14, the NN arithmetic processing of the second embodiment is the same as the NN arithmetic processing of the first embodiment.

In the second embodiment, the arithmetic circuit 12 periodically executes similarity determination processing (steps S20 and S22 in FIG. 7). For example, the arithmetic circuit 12 executes the similarity determination processing every P executions of the NN arithmetic processing (where P is an integer). In the similarity determination processing, the arithmetic circuit 12 calculates the similarity between the Q most recently input first image data Ga and the Q previously input second image data Gb, and determines whether to execute the quantization parameter change processing (i.e., steps S2 to S8) based on the similarity. In FIG. 8, Q=4 is shown as an example. The similarity determination processing is described in detail below.

In step S20, the arithmetic circuit 12 identifies the first image data Ga and the second image data Gb from the multiple image data G stored in the storage device 14. The arithmetic circuit 12 identifies the most recent Q pieces of image data G (G1 to G4 in FIG. 8) as the first image data Ga. The arithmetic circuit 12 also identifies the Q pieces of image data G immediately preceding the first image data Ga (G5 to G8 in FIG. 8) as the second image data Gb.

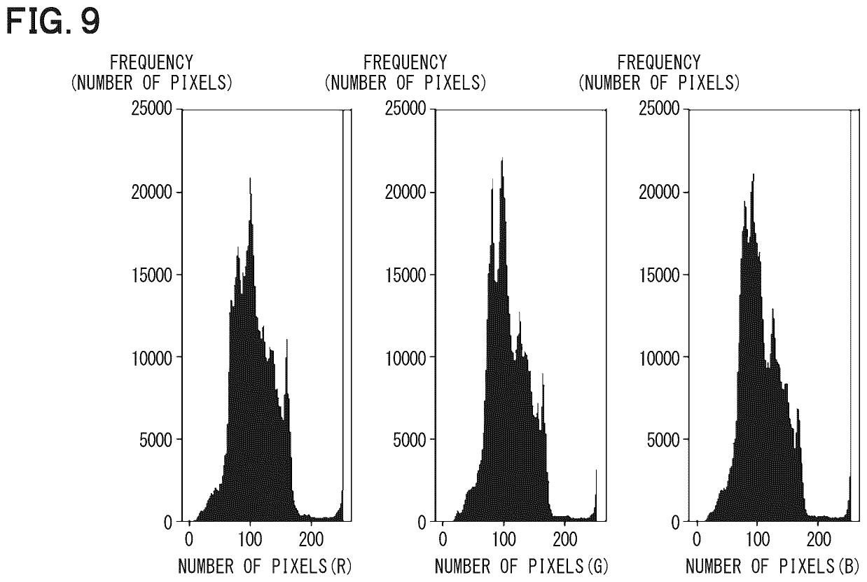

Furthermore, in step S20, the arithmetic circuit 12 identifies the distribution of pixel values of the first image data Ga and the second image data Gb. Pixel values are values assigned to each pixel, indicating the brightness of the pixel. Pixel values are provided for each of RGB (red, green, blue). Pixel values are represented by 256 levels ranging from 0 to 255. FIG. 9 illustrates the distribution of pixel values for each of RGB in the first image data Ga. The horizontal axis of FIG. 9 represents pixel values (i.e., values from 0 to 255). The vertical axis of FIG. 9 represents the number of pixels having the corresponding pixel value (i.e., the frequency of occurrence of pixels with the corresponding pixel value). The vertical axis of FIG. 9 shows the cumulative number of pixels for all Q first image data Ga. As shown in FIG. 9, the arithmetic circuit 12 calculates histograms for each of RGB for the first image data Ga. Similarly, the arithmetic circuit 12 calculates histograms for each of RGB for the second image data Gb.

Furthermore, in step S20, the arithmetic circuit 12 calculates the similarity between the first image data Ga and the second image data Gb based on their histograms. Various indices such as correlation coefficient, KL divergence, and three-dimensional Euclidean distance can be used as indicators of similarity. After calculating the similarity, the arithmetic circuit 12 determines in step S22 whether the similarity is lower than a reference value and decides whether to execute the quantization parameter change processing based on the determination.

### (When Using Correlation Coefficient)

When using the correlation coefficient, the arithmetic circuit 12 calculates the correlation coefficient D using the following equations 5 and 6. The arithmetic circuit 12 calculates the correlation coefficient D for each of RGB. The correlation coefficients for RGB are referred to as Dr, Dg, and Db, respectively.

$$D = \frac{{Σ}_{I} ( {H}_{1} ( I ) - {\overline{H}}_{1} ) ( {H}_{2} ( I ) - {\overline{H}}_{2} )}{\sqrt{{Σ}_{I} {( {H}_{1} ( I ) - {\overline{H}}_{1} )}^{2} {Σ}_{J} {( {H}_{2} ( I ) - {\overline{H}}_{2} )}^{2}}} \qquad ( Equation 5 )$$

$${\overline{H}}_{k} = \frac{1}{N} {Σ}_{J} {H}_{k} ( J ) \qquad ( Equation 6 )$$

In the equations, H₁(I) is the value of the I-th bin of the histogram of the first image data Ga (i.e., the number of pixels with the pixel value corresponding to the I-th bin), H₂(I) is the value of the I-th bin of the histogram of the second image data Gb (i.e., the number of pixels with the pixel value corresponding to the I-th bin), and N is the total number of bins (i.e., 256). The values calculated by the equation 6 are the average values of the number of pixels in each bin of the histogram. The higher the correlation coefficient D, the higher the similarity between the first image data Ga and the second image data Gb. After calculating the correlation coefficients Dr, Dg, and Db for each of RGB, the arithmetic circuit 12 calculates the average value Dave of the correlation coefficients Dr, Dg, and Db. In this way, the arithmetic circuit 12 calculates the average value Dave of the correlation coefficients as an indicator of similarity in step S20. Next, in step S22, the arithmetic circuit 12 determines whether the average value Dave is lower than the reference value Dth. If the average value Dave is lower than the reference value Dth (i.e., if the similarity is lower than the reference value), the arithmetic circuit 12 determines YES in step S22 and executes the quantization parameter change processing. The quantization parameter change processing is executed in the same manner as in the first embodiment. If the average value Dave is equal to or higher than the reference value Dth (i.e., if the similarity is equal to or higher than the reference value), the arithmetic circuit 12 determines NO in step S22 and ends the processing without executing the quantization parameter change processing. In this way, the arithmetic circuit 12 uses the correlation coefficient D as an indicator of similarity and executes the quantization parameter change processing only when the similarity is low.

### (When Using KL Divergence)

When using KL divergence, the arithmetic circuit 12 calculates the KL divergence DKL using the following equation 7. The arithmetic circuit 12 calculates the KL divergence DKL for each of RGB. The KL divergences for RGB are referred to as DKLr, DKLg, and DKLb, respectively.

$$D KL = {Σ}_{I} {H}_{1} ( I ) log ( \frac{{H}_{1} ( I )}{{H}_{2} ( I )} ) \qquad ( Equation 7 )$$

In the equation, H₁(I) is the value of the I-th bin of the histogram of the first image data Ga (i.e., the number of pixels with the pixel value corresponding to the I-th bin), and H₂(I) is the value of the I-th bin of the histogram of the second image data Gb (i.e., the number of pixels with the pixel value corresponding to the I-th bin). KL divergence DKL quantifies the difference between the two histograms. The lower the KL divergence DKL, the higher the similarity between the first image data Ga and the second image data Gb. After calculating the KL divergences DKLr, DKLg, and DKLb for each of RGB, the arithmetic circuit 12 calculates the average value DKLave of the KL divergences DKLr, DKLg, and DKLb. In this way, the arithmetic circuit 12 calculates the average value DKLave of the KL divergences as an indicator of similarity in step S20. Next, in step S22, the arithmetic circuit 12 determines whether the average value DKLave is higher than the reference value DKLth. As described above, the KL divergence is lower when the similarity is higher. Therefore, determining whether the average value DKLave is higher than the reference value DKLth is equivalent to determining whether the similarity is lower than the reference value. If the average value DKLave is higher than the reference value DKLth (i.e., if the similarity is lower than the reference value), the arithmetic circuit 12 determines YES in step S22 and executes the quantization parameter change processing. If the average value DKLave is equal to or lower than the reference value DKLth (i.e., if the similarity is equal to or higher than the reference value), the arithmetic circuit 12 determines NO in step S22 and ends the processing without executing the quantization parameter change processing. In this way, the arithmetic circuit 12 uses the KL divergence DKL as an indicator of similarity and executes the quantization parameter change processing only when the similarity is low.

### (When Using Three-Dimensional Euclidean Distance)

When using three-dimensional Euclidean distance, the arithmetic circuit 12 calculates the average pixel values of the first image data Ga and the second image data Gb. The arithmetic circuit 12 calculates the average pixel values for each of RGB. The average pixel values of RGB for the first image data Ga are referred to as Ar, Ag, and Ab, and the average pixel values of RGB for the second image data Gb are referred to as Br, Bg, and Bb. Next, the arithmetic circuit 12 calculates the three-dimensional Euclidean distance X using the following equation 8.

$$X = \frac{\sqrt{{( {A}_{r} - {B}_{r} )}^{2} + {( {A}_{g} - {B}_{g} )}^{2} + {( {A}_{b} - {B}_{b} )}^{2}}}{\sqrt{3 \times 25 {5}^{2}}} \qquad ( Equation 8 )$$

The denominator on the right side of equation 8 is a constant for normalizing the three-dimensional Euclidean distance X, and this constant may be omitted. The smaller the three-dimensional Euclidean distance X, the higher the similarity between the first image data and the second image data. In this way, the arithmetic circuit 12 calculates the three-dimensional Euclidean distance X as an indicator of similarity in step S20. Next, in step S22, the arithmetic circuit 12 determines whether the three-dimensional Euclidean distance X is higher than the reference value Xth. As described above, the three-dimensional Euclidean distance X is lower when the similarity is higher. Therefore, determining whether the three-dimensional Euclidean distance X is higher than the reference value Xth is equivalent to determining whether the similarity is lower than the reference value. If the three-dimensional Euclidean distance X is higher than the reference value Xth (i.e., if the similarity is lower than the reference value), the arithmetic circuit 12 determines YES in step S22 and executes the quantization parameter change processing. If the three-dimensional Euclidean distance X is equal to or lower than the reference value Xth (i.e., if the similarity is equal to or higher than the reference value), the arithmetic circuit 12 determines NO in step S22 and ends the processing without executing the quantization parameter change processing. In this way, the arithmetic circuit 12 uses the three-dimensional Euclidean distance X as an indicator of similarity and executes the quantization parameter change processing only when the similarity is low.

As described above, the arithmetic circuit 12 calculates the similarity between the most recently captured first image data Ga and the previously captured second image data Gb and executes the quantization parameter change processing only when the similarity is low. Therefore, the quantization parameter change processing is executed when the scenery in front of the vehicle changes significantly. Consequently, quantization errors can be appropriately reduced. Additionally, when the change in the scenery in front of the vehicle is small and there is no need to change the quantization parameters, the quantization parameter change processing is not executed, thereby reducing the frequency of executing the quantization parameter change processing.

Additionally, there may be instances where the pixel values of the image data captured by the camera 16 change significantly for a short period while the vehicle is in motion. For example, if the light from an oncoming vehicle's headlights directly enters the camera 16, the pixel values of the image data will be high at that moment but will return to normal values immediately afterward. If the quantization parameter change processing is performed during such sudden changes in pixel values, it may not be possible to set the quantization parameters appropriately. In contrast, the second embodiment can appropriately handle sudden changes in pixel values. For example, consider a case where the pixel values are high only in the image data G2 due to a sudden change in pixel values. In this case, the arithmetic circuit 12 determines whether to perform the quantization parameter change processing based on the similarity between the four first image data Ga (i.e., G1 to G4) and the four second image data Gb (i.e., G5 to G8). Even if the pixel values are high only in the image data G2, if the overall change in pixel values in the first image data Ga is small, the arithmetic circuit 12 will determine that the similarity between the first image data Ga and the second image data Gb is high and will not perform the quantization parameter change processing. Thus, according to the second embodiment, the modification of the quantization parameters can be suppressed when there is a sudden change in pixel values. This prevents the quantization parameters from being changed to inappropriate values.

Furthermore, in the second embodiment, since the similarity determination processing (i.e., steps S20 and S22) and the quantization parameter change processing (i.e., steps S2 to S8) are executed in parallel with the NN arithmetic processing, the NN arithmetic processing can be accelerated.

Although FIG. 8 illustrates the case where Q=4, the integer Q can be set to any value. Similarly, the integer P (i.e., the frequency of executing the similarity determination processing) can be set to any value. For example, Q can be greater than P, or Q can be less than P. P and Q can also be 1. When P is 1, the similarity determination processing is executed once for each execution of the NN arithmetic processing. When Q is 1, there is one first image data Ga and one second image data Gb. Additionally, in FIG. 8, the first image data Ga and the second image data Gb are continuous in the time series, but there may be a time interval between the first image data Ga and the second image data Gb. For example, the first image data Ga may be composed of image data G1 to G4, and the second image data Gb may be composed of image data G7 to G10.

Furthermore, in FIG. 8, the image data immediately preceding the first image data Ga is used as the second image data Gb, but the image data at the time of the last execution of the quantization parameter change processing may be used as the second image data Gb.

The structure of the neural network 42 shown in FIG. 2 is merely an example. The number of intermediate layers 46 in the neural network 42 can be arbitrary, and the types of layers arranged as the intermediate layers 46 can also be arbitrary. In the described embodiments, the output data of the convolutional layer is input to the quantization layer, but the data input to the quantization layer can be the output data of any intermediate layer. For example, the output data of a pooling layer, a fully connected layer, or an activation function can be input to the quantization layer. In this case, the output data of the intermediate layer preceding the quantization layer can be stored in the storage device 14, and the quantization parameter change processing can be executed based on the distribution of values in the output data.

Additionally, although the information processing device 10 of the described embodiments analyzed the image data in front of the vehicle using a neural network, the technology disclosed in this specification can be applied to the analysis of other image data. For example, the technology disclosed in this specification can be applied when capturing images in front of or around other vehicles (airplanes, ships, etc.) or drones and repeatedly inputting the image data to a neural network. The technology disclosed in this specification can also be applied when repeatedly inputting each frame of a video to a neural network. Since the technology disclosed in this specification can reduce the computational load of the arithmetic circuit and accelerate the NN arithmetic processing, it is particularly useful for standalone devices (e.g., in-vehicle devices) with limited processing capabilities.

In the described embodiments, the maximum value Max and the minimum value Min are identified from the pixel values of the feature map 50, and the quantization parameters S value and Z value are calculated based on the maximum value Max and the minimum value Min. However, as long as the quantization parameters can be calculated from the distribution of values, the quantization parameters can be calculated in any manner. For example, the quantization parameters can be calculated based on indicators other than the maximum value Max and the minimum value Min. Additionally, values other than the S value and Z value can be used as the quantization parameters.

While the embodiments have been described in detail, these are merely examples and do not limit the scope of the claims. The technology described in the claims includes various modifications and changes to the specific examples illustrated above. The technical elements described in this specification or the drawings can exhibit technical utility individually or in various combinations and are not limited to the combinations described in the claims at the time of filing. Additionally, the technology illustrated in this specification or the drawings achieves multiple objectives simultaneously, and achieving any one of these objectives alone provides technical utility.

What is claimed is:

1. An information processing device comprising
a storage device configured to store a neural network and a quantization parameter, and
an arithmetic circuit,
wherein
the neural network includes a specific intermediate layer and a quantization layer that quantizes data, which is a set of values output by the specific intermediate layer, based on the quantization parameter, and
the arithmetic circuit executes repeated processing that repeatedly executes arithmetic processing that obtains an output result of the neural network by inputting image data into the neural network and stores the data output by the specific intermediate layer in the storage device, and in parallel with the repeated processing, executes modification processing that modifies the quantization parameter based on a distribution of values in the data stored in the storage device.

2. The information processing device according to claim 1, wherein
the arithmetic circuit accumulates a plurality of the data output by the specific intermediate layer in the storage device during a plurality of the arithmetic processing, and
the arithmetic circuit modifies the quantization parameter based on the distribution of values in the plurality of the data accumulated in the storage device in the modification processing.

3. The information processing device according to claim 1, wherein
the information processing device is mounted on a vehicle,
the information processing device further comprises a camera configured to capture an image in front of the vehicle, and
the arithmetic circuit inputs an image data captured by the camera into the neural network during the arithmetic processing.

4. The information processing device according to claim 3, wherein
the arithmetic circuit determines timing for executing the modification processing based on a travel distance of the vehicle.

5. The information processing device according to claim 3, wherein
the arithmetic circuit determines timing for executing the modification processing based on location information of the vehicle.

6. The information processing device according to claim 1, wherein
during the arithmetic processing, the arithmetic circuit stores the image data input into the neural network in the storage device, identifies at least one first image data and at least one second image data that has been input into the neural network before the first image data from the image data stored in the storage device, and executes the modification processing when similarity between the first image data and the second image data is lower than a reference value.

7. The information processing device according to claim 1, wherein
the arithmetic circuit determines timing for executing the modification processing based on time.

8. The information processing device according to claim 1, wherein
the arithmetic circuit identifies amount of change in the quantization parameter during the modification processing, and determines timing for executing a next modification processing, causing interval until the next modification processing to be longer as the amount of change is smaller.

9. An information processing method executed by an information processing device having a storage device, wherein the storage device stores a neural network and a quantization parameter, the neural network includes a specific intermediate layer and a quantization layer that quantizes data, which is a set of values output by the specific intermediate layer, based on the quantization parameter, the method comprising:
repeatedly executing arithmetic processing to obtain an output result of the neural network by inputting image data into the neural network and store the data output by the specific intermediate layer in the storage device; and
in parallel with the arithmetic processing, modifying the quantization parameter based on a distribution of values in the data stored in the storage device.

10. A non-transitory computer readable storage medium storing a program having a neural network, wherein the neural network includes a specific intermediate layer and a quantization layer that quantizes data, which is a set of values output by the specific intermediate layer, based on a quantization parameter, the program causing an information processing device to:
execute repeated processing that repeatedly executes arithmetic processing that obtains an output result of the neural network by inputting image data into the neural network and stores the data output by the specific intermediate layer in a storage device of the information processing device; and
execute modification processing that, in parallel with the arithmetic processing, modifies the quantization parameter based on a distribution of values in the data stored in the storage device.
